(19) United States
(12) Patent Application Publication
(10) Pub. No.: US 2020/0391859 A1
(43) Pub. Date: Dec. 17, 2020

(54) VTOL AIRCRAFT WITH LEADING EDGE TILTING DUCTED FANS

(71) Applicant: Bell Textron Inc., Fort Worth, TX (US)

(72) Inventors: Kirk L. GRONINGA, Keller, TX (US); Daniel B. ROBERTSON, Southlake, TX (US); Matthew E. LOUIS, Fort Worth, TX (US)

(73) Assignee: Bell Textron Inc., Fort Worth, TX (US)

(21) Appl. No.: 16/438,691

(22) Filed: Jun. 12, 2019

(51) Int. Cl. B64C 29/00

(52) U.S. Cl. CPC B64C 29/0033

(57) ABSTRACT

An exemplary ducted fan includes a circular duct surrounding a rotor hub from which blades radially extend, a stator having a stator leading edge and a stator trailing edge, and a stator chord line extending from the stator leading edge to the stator trailing edge, the stator chord line substantially equal to a duct radius from the rotor hub to an outer surface of the duct.

### TECHNICAL FIELD

The present disclosure relates, in general, to aircraft having a forward flight mode and a vertical takeoff and landing flight mode and, in particular, to an aircraft having tiltable ducted fans on the leading edge of the wings that are operable to transition between a forward thrust orientation and a vertical lift or hover orientation.

### BACKGROUND

This section provides background information to facilitate a better understanding of the various aspects of the disclosure. It should be understood that the statements in this section of this document are to be read in this light, and not as admissions of prior art.

Fixed-wing aircraft, such as airplanes, are capable of flight using wings that generate lift responsive to the forward airspeed of the aircraft, which is generated by forward thrust from one or more jet engines or propellers. The wings have an airfoil cross section that deflects air downwardly as the aircraft moves forward, generating vertical lift to support the airplane in flight. Fixed-wing aircraft, however, require a runway for takeoff and landing.

Unlike fixed-wing aircraft, vertical takeoff and landing (VTOL) aircraft do not require runways. Instead, VTOL aircraft are capable of taking off, hovering and landing vertically. One example of VTOL aircraft is a helicopter, which is a rotorcraft having one or more rotors that provide vertical lift and forward thrust to the aircraft. Helicopter rotors not only enable hovering, vertical takeoff and vertical landing, but also enable, forward, aftward and lateral flight. These attributes make helicopters highly versatile for use in congested, isolated or remote areas where fixed-wing aircraft may be unable to takeoff and land. Helicopters, however, typically lack the forward airspeed of fixed-wing aircraft.

A tiltrotor aircraft is another example of a VTOL aircraft. Tiltrotor aircraft utilize tiltable rotor systems that are operable to transition between a forward thrust orientation and a vertical lift orientation. The rotor systems are tiltable relative to a fixed wing such that the associated proprotors have a generally horizontal plane of rotation for vertical takeoff, hovering and vertical landing and a generally vertical plane of rotation for forward flight, wherein the fixed wing provides lift. In this manner, tiltrotor aircraft combine the vertical lift capability of a helicopter with the speed and range of fixed-wing aircraft.

### SUMMARY

An exemplary ducted fan includes a circular duct surrounding a rotor hub from which blades radially extend, a stator having a stator leading edge and a stator trailing edge, and a stator chord line extending from the stator leading edge to the stator trailing edge, the stator chord line substantially equal to a duct radius from the rotor hub to an outer surface of the duct.

An exemplary aircraft having a vertical takeoff and landing flight mode and a forward flight mode includes a left wing extending laterally from a fuselage to a left wing tip, a left ducted fan rotatably coupled at a leading edge of the left wing between the fuselage and the left wing tip, the left ducted fan rotatable from a vertical lift, a right wing extending laterally from the fuselage to a right wing tip, and a right ducted fan rotatably coupled at a leading edge of the right wing between the fuselage and the right wing tip, wherein the left and the right ducted fan are rotatable between a vertical lift orientation with a portion of the ducted fan positioned in and opening in the corresponding left and right wing between the wing leading edge and a wing trailing edge and a forward thrust orientation. In an exemplary aircraft, the left and the right ducted fans each includes a circular duct surrounding a rotor hub from which blades radially extend, a stator having a stator leading edge and a stator trailing edge and a stator chord line extending from the stator leading edge to the stator trailing edge, the stator chord line substantially equal to a duct radius from the rotor hub to an outer surface of the duct, wherein the stator is positioned in the opening when the left and the right ducted fans are in the forward thrust orientation.

This summary is provided to introduce a selection of concepts that are further described below in the detailed description. This summary is not intended to identify key or essential features of the claimed subject matter, nor is it intended to be used as an aid in limiting the scope of claimed subject matter.

### BRIEF DESCRIPTION OF THE DRAWINGS

The disclosure is best understood from the following detailed description when read with the accompanying figures. It is emphasized that, in accordance with standard practice in the industry, various features are not drawn to scale. In fact, the dimensions of various features may be arbitrarily increased or reduced for clarity of discussion.

FIG. 1 is a perspective illustration of an exemplary VTOL aircraft with ducted fans on the wing leading edge in a hover mode.

FIG. 2 illustrates a top view of an exemplary VTOL aircraft with ducted fans on the wing leading edge in the hover mode.

FIG. 3 illustrates a front view of an exemplary VTOL aircraft with ducted fans on the wing leading edge in the hover mode.

FIG. 4 illustrates a side view of an exemplary VTOL aircraft with ducted fans on the wing leading edge in the hover mode.

FIG. 5 is a perspective illustration of an exemplary VTOL aircraft with ducted fans on the wing leading edge in the forward flight mode.

FIG. 6 illustrates a top view of an exemplary VTOL aircraft with ducted fans on the wing leading edge in the forward flight mode.

FIG. 7 illustrates a side view of an exemplary VTOL aircraft with ducted fans on the wing leading edge in the forward flight mode.

FIG. 8 illustrates a top view of another exemplary VTOL aircraft with ducted fans on the wing leading edge in the forward flight mode.

### DETAILED DESCRIPTION

It is to be understood that the following disclosure provides many different embodiments, or examples, for implementing different features of various illustrative embodiments. Specific examples of components and arrangements are described below to simplify the disclosure. These are, of course, merely examples and are not intended to be limiting. For example, a figure may illustrate an exemplary embodiment with multiple features or combinations of features that are not required in one or more other embodiments and thus a figure may disclose one or more embodiments that have fewer features or a different combination of features than the illustrated embodiment. Embodiments may include some but not all the features illustrated in a figure and some embodiments may combine features illustrated in one figure with features illustrated in another figure. Therefore, combinations of features disclosed in the following detailed description may not be necessary to practice the teachings in the broadest sense and are instead merely to describe particularly representative examples. In addition, the disclosure may repeat reference numerals and/or letters in the various examples. This repetition is for the purpose of simplicity and clarity and does not itself dictate a relationship between the various embodiments and/or configurations discussed.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms such as “inboard,” “outboard,” “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction. As used herein, the terms “connect,” “connection,” “connected,” “in connection with,” and “connecting” may be used to mean in direct connection with or in connection with via one or more elements. Similarly, the terms “couple,” “coupling,” and “coupled” may be used to mean directly coupled or coupled via one or more elements.

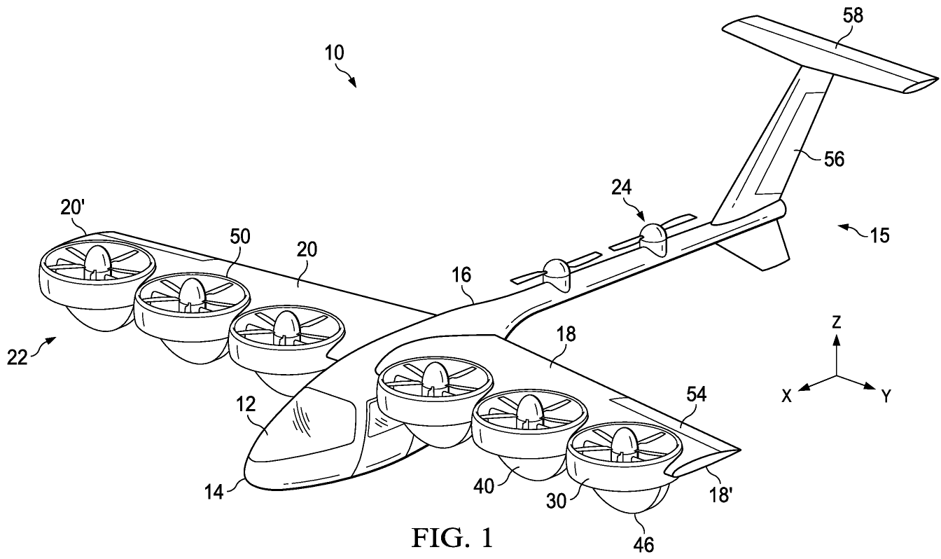

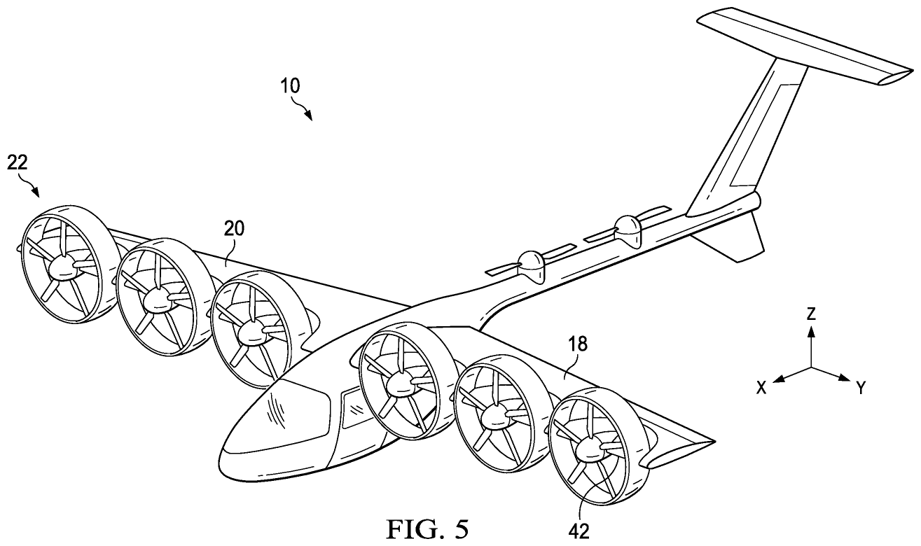

FIGS. 1 and 5 depict three mutually orthogonal directions X, Y, and Z forming a three-dimensional frame of reference XYZ. Longitudinal axis X corresponds to the roll axis that extends through the center of aircraft 10 in the fore and after directions. Transverse axis Y is perpendicular to longitudinal axis X and corresponds to the pitch axis (also known as a control pitch axis or “CPA”). The X-Y plane is considered to be “horizontal.” Vertical axis Z is the yaw axis and is oriented perpendicularly with respect to the X-Y plane. The X-Z plane and Y-Z plane are considered to be “vertical.”

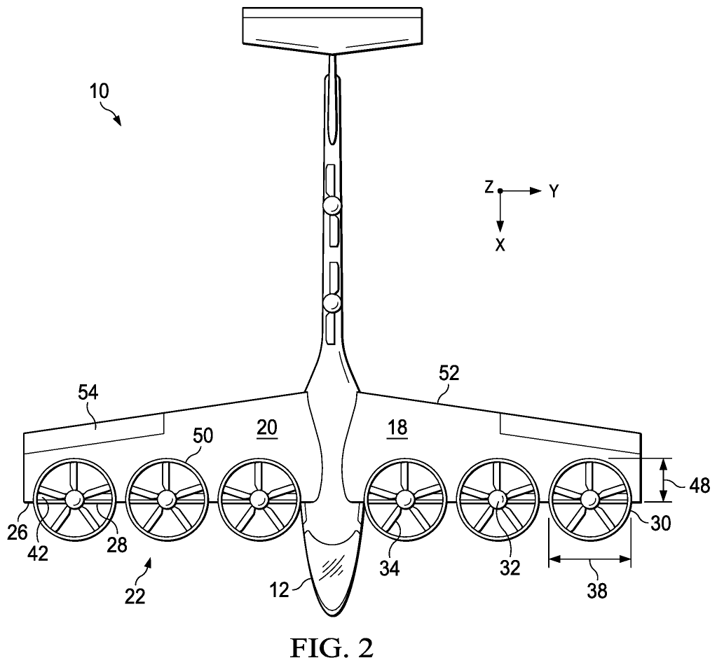

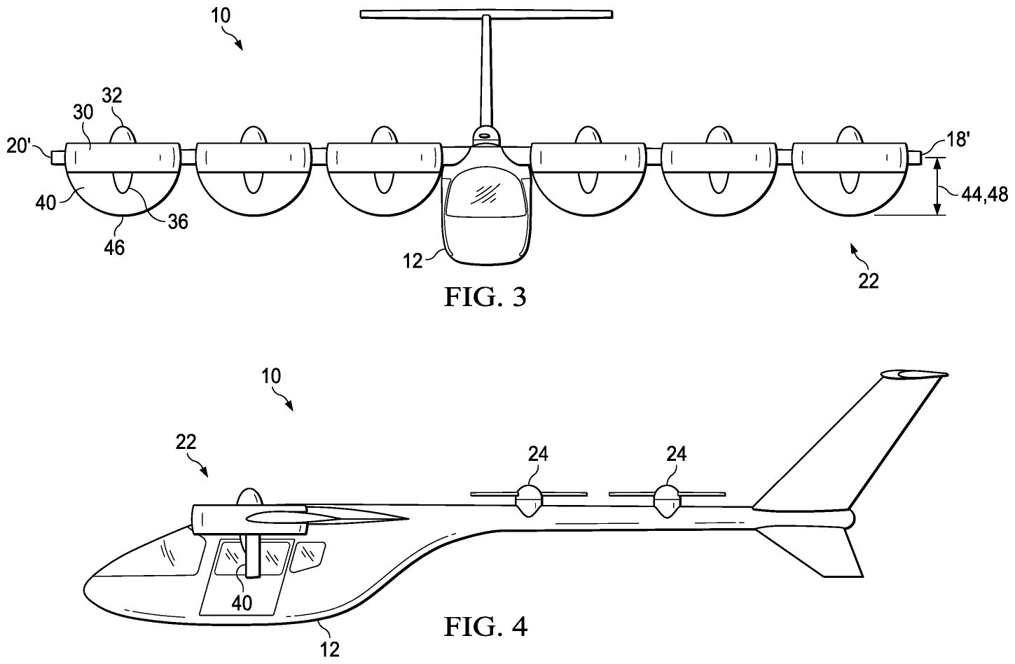

FIGS. 1-7 illustrate an exemplary vertical takeoff and landing (VTOL) aircraft 10 in different flight modes. FIGS. 1-4 illustrate an exemplary aircraft 10 in a VTOL or hover mode and FIGS. 5-7 illustrate aircraft 10 in a forward flight or airplane mode. Aircraft 10 includes a fuselage 12 as a central main body. Fuselage 12 extends parallel to longitudinal axis X from a fuselage front end 14 to fuselage rear end 16. Exemplary aircraft 10 includes an empeanage 15, i.e. tail member, at rear end 16. Aircraft 10 has a left wing 18 and a right wing 20 extending laterally in opposite directions from fuselage 12 to respective wing tips 18′ and 20′. Aircraft 10 includes a rotary propulsion system incorporating one or more tiltable ducted fans 22 located on each wing 18, 20 between fuselage 12 and wing tips 18′ and 20′. Tiltable ducted fans 22 may be tilted between a horizontal, vertical lift orientation in the hover mode and a vertical, forward thrust orientation in the airplane mode. Tiltable ducted fans 22 may also pivot, in particular in the hover mode, to provide yaw control by differential left and right ducted fan tilt. In some embodiments, ducted fans 22 may have a stator in the form of an articulated vane for yaw control in the hover mode.

Exemplary aircraft 10 includes a tail rotor 24 oriented to rotate in a horizontal plane, for example to provide vertical lift and pitch control in hover mode. In the illustrated example, aircraft 10 includes two tail rotors 24 equalizing the vertical lift distribution across aircraft 10. Teachings of certain embodiments recognize that tail rotor 24 may represent one example of a rotor; other examples include, but are not limited to, tail propellers, and fans mounted inside and/or outside the aircraft. It should be appreciated that teachings herein apply to manned and unmanned vehicles and aircraft including without limitation airplanes, rotorcraft, hovercraft, helicopters, and rotary-wing vehicles.

Ducted fans 22 are rotatably or tiltably supported at the leading edge 26 of wings 18, 20. Ducted fans 22 may be rotatably coupled to a spar 28 substantially at wing leading edge 26. Ducted fan 22 includes a duct 30 that surrounds, or partially encloses, a rotor hub 32 from which a plurality of blades 34 radially extend. Blades 34 can be collectively manipulated to selectively control direction, thrust and lift of aircraft 10. The collective pitch of blades 34 may be independently controlled from one another to allow for different thrusts by each ducted fan 22. Rotor hub 32 may include a nacelle 36 housing a power supply such as an electric or hydraulic motor. Nacelle 36 extends behind hub 32 along the axis of rotation of blades 34. Ducted fans 22, i.e. ducts 30, are substantially circular and coupled to wing leading edge 26 along the horizontal duct diameter 38 such that in the airplane mode the top half of ducted fans 22, above horizontal duct diameter 38, is positioned above the wing and the bottom half of ducted fan 22 is positioned above the wing. Diameter 38 of the ducted fans 22 correlates to the outside diameter of ducts 30 for the purpose of correlating with the opening 50 formed in wings 18, 20.

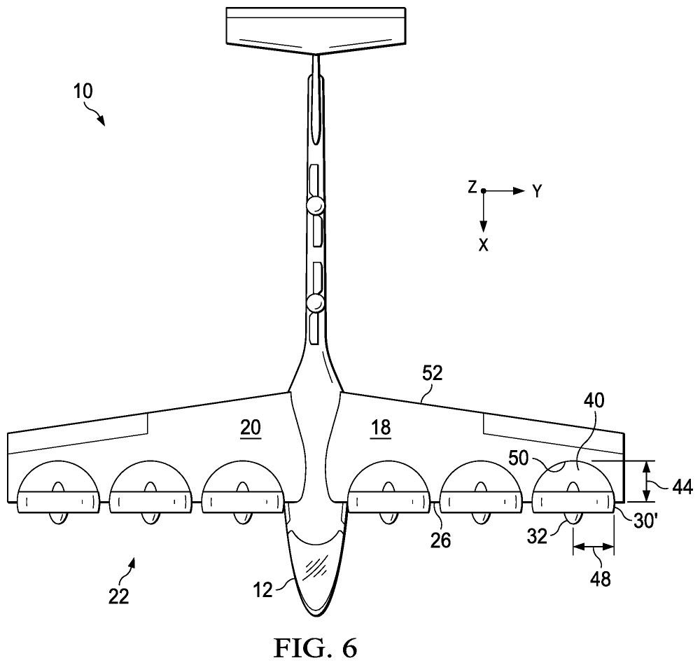

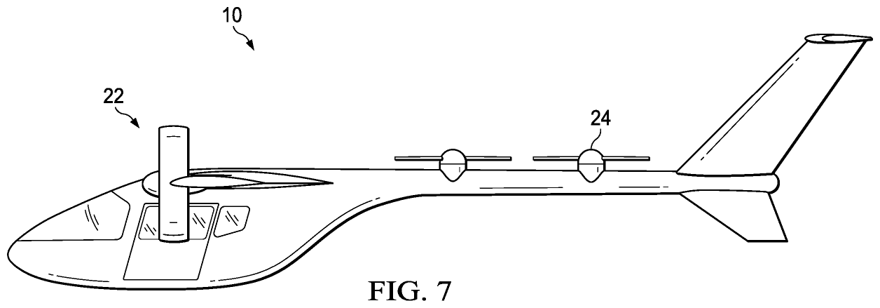

Ducted fans 22 include a horizontal stator 40, or vane 40, that extends generally parallel to wings 18, 20. Stator 40 is located behind blades 34 and located inside duct 30 to reduce or eliminate the swirl and torque produced by blades 34. Stator 40 may also provide structural integrity. Stator 40 has a leading edge 42 extending along horizontal duct diameter 38 and a duct chord line 44 extending from stator leading edge 42 to a stator trailing edge 46. Stator leading edge 42 and wing leading edge 26 are on the same horizontal X-Y plane. Stator chord line 44 is generally equal to the radius 48 of ducted fan 22, the radius to the outside diameter of duct 30, such that the planar profile of stator 40 along radius 48 has a semi-circular shape that matches the top half of ducted fan 22. Radius 48 may be measured for example from rotor hub 32 to the outer surface 30′ of duct 30 as illustrated in FIG. 6. Stator 40 has an airfoil shape, see for example FIGS. 4 and 7, extending along stator chord line 44 that corresponds to the airfoil shape of the portion of wings 18, 20 that extends from wing leading edge 26 the length of stator chord line 44. The airfoil shape of stator 40 may include the height of stator 40 along the vertical plane X-Z tapering down from stator leading edge 42 to stator trailing edge 46. Thus, in the forward flight mode, stator 40 is a continuous portion of the wing matching the airfoil shape of the wing.

Wings 18, 20 have semi-circular openings 50 formed at leading edge 26 into which half of ducted fans 22, i.e. ducts 30, are positioned when in the hover mode, as shown for example in FIGS. 1-4. Accordingly, semi-circular openings 50 have a radius generally equal to the radius 48 of ducted fans 22. When aircraft 10 is in the airplane mode, stator 40 fills opening 50 such that a continuous wing, without an opening, is formed between wing leading edge 26 and wing trailing edge 52.

As best seen in FIGS. 1-4, aircraft 10 has a VTOL or hover mode where the ducted fans 22 are oriented in the vertical lift orientation. In the hover mode, ducted fans 22 are rotated about wing leading edge 26 such that the top halves of ducted fans 22 fill the corresponding openings 50. The positioning of ducted fans 22 in openings 50 eliminates any propwash download on aircraft 10. In hover mode, roll control can be achieved via differential left and right ducted fan 22 thrust, yaw control can be achieved by differential left and right ducted fan 22 tilt, and pitch can be controlled for example via tail rotor 24. Stator 40 may be in an articulated vane configuration to achieve yaw control.

As best seen in FIGS. 5-7, aircraft 10 has an airplane or forward flight mode where ducted fans 22 are rotated about wing leading edge 26 into the forward thrust orientation. In the airplane mode, stators 40 fill wing openings 50 in the horizontal X-Y plane as well as in the vertical X-Z plane such that a continuous wing 18, 20 exists. In the airplane mode, roll control may be achieved through ailerons 54, yaw control may be achieved through rudder 56, and pitch control may be achieved through elevator 58.

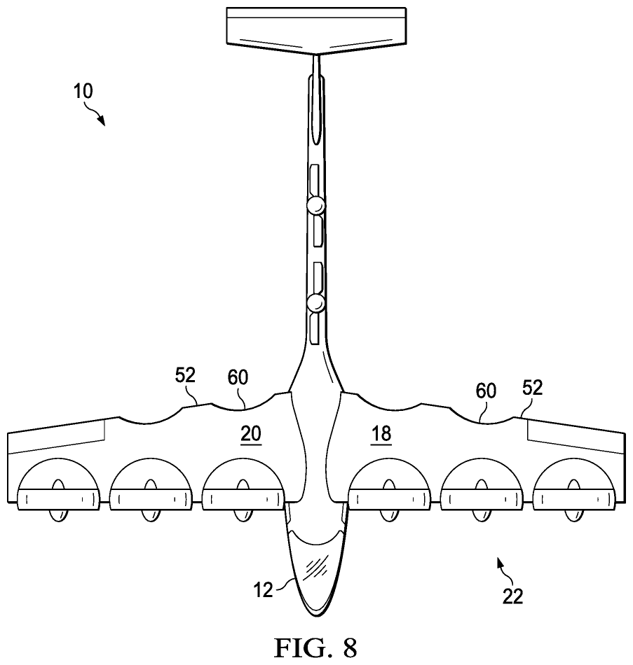

FIG. 8 illustrates another exemplary aircraft 10. In this example, wing trailing edge 52 is parabolic shaped with concave cut-outs 60 positioned along wing trailing edge 52 behind one or more of ducted fans 22. The parabolic or semi-circular cut-outs 60 are configured to reduce the induced drag and to improve cruise mode efficiency. Ducted fans 22 may act as a ring wing and produce discontinuity in the lift distribution along the spans of wings 18, 20. Providing cut-outs 60 may reduce the induced drag and the discontinuity in the lift distribution.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include such elements or features.

The term “substantially,” “approximately,” and “about” is defined as largely but not necessarily wholly what is specified (and includes what is specified; e.g., substantially 90 degrees includes 90 degrees and substantially parallel includes parallel), as understood by a person of ordinary skill in the art. The extent to which the description may vary will depend on how great a change can be instituted and still have a person of ordinary skill in the art recognized the modified feature as still having the required characteristics and capabilities of the unmodified feature. In general, but subject to the preceding, a numerical value herein that is modified by a word of approximation such as “substantially,” “approximately,” and “about” may vary from the stated value, for example, by 0.1, 0.5, 1, 2, 3, 4, 5, 10, or 15 percent.

The foregoing outlines features of several embodiments so that those skilled in the art may better understand the aspects of the disclosure. Those skilled in the art should appreciate that they may readily use the disclosure as a basis for designing or modifying other processes and structures for carrying out the same purposes and/or achieving the same advantages of the embodiments introduced herein. Those skilled in the art should also realize that such equivalent constructions do not depart from the spirit and scope of the disclosure and that they may make various changes, substitutions, and alterations without departing from the spirit and scope of the disclosure. The scope of the invention should be determined only by the language of the claims that follow. The term “comprising” within the claims is intended to mean “including at least” such that the recited listing of elements in a claim are an open group. The terms “a,” “an” and other singular terms are intended to include the plural forms thereof unless specifically excluded.

What is claimed is:

1. A ducted fan comprising:
a circular duct surrounding a rotor hub from which blades radially extend;
a stator having a stator leading edge and a stator trailing edge; and
a stator chord line extending from the stator leading edge to the stator trailing edge, the stator chord line substantially equal to a duct radius from the rotor hub to an outer surface of the duct.

2. The ducted fan of claim 1, wherein the stator leading edge is located inside of the duct and the trailing edge is located exterior of the duct.

3. The ducted fan of claim 1, wherein the stator is an articulating vane.

4. The ducted fan of claim 1, wherein the stator leading edge is located inside of the duct and extends along a diameter of the duct;
the trailing edge is located exterior of the duct; and
the trailing edge has a semi-circular shape corresponding to the duct radius.

5. The ducted fan of claim 4, wherein the stator is an articulating vane.

6. The ducted fan of claim 1, wherein the stator leading edge is located inside of the duct;
the trailing edge is located exterior of the duct;
the stator has a width exterior of the duct that is substantially equal to an outside diameter of the duct; and
the trailing edge has a semi-circular shape corresponding to the duct radius.

7. The ducted fan of claim 6, wherein the stator is an articulating vane.

8. The ducted fan of claim 1, wherein the stator has a height that tapers down from the stator leading edge toward the stator trailing edge.

9. The ducted fan of claim 8, wherein the stator is an articulating vane.

10. The ducted fan of claim 1, wherein the stator leading edge is located inside of the duct and extends along a diameter of the duct;
the trailing edge is located exterior of the duct;
the trailing edge has a semi-circular shape corresponding to the duct radius; and
the stator has a height that tapers down from the stator leading edge toward the stator trailing edge.

11. The ducted fan of claim 10, wherein the stator is an articulating vane.

12. The ducted fan of claim 10, wherein the stator has a width exterior of the duct that is substantially equal to an outside diameter of the duct.

13. The ducted fan of claim 12, wherein the stator is an articulating vane.

14. An aircraft having a vertical takeoff and landing (VTOL) flight mode and a forward flight mode, the aircraft comprising:
a left wing extending laterally from a fuselage to a left wing tip;
a left ducted fan rotatably coupled at a leading edge of the left wing between the fuselage and the left wing tip, the left ducted fan rotatable from a vertical lift;
a right wing extending laterally from the fuselage to a right wing tip; and
a right ducted fan rotatably coupled at a leading edge of the right wing between the fuselage and the right wing tip;
wherein the left and the right ducted fan are rotatable between a vertical lift orientation with a portion of the ducted fan positioned in and opening in the corresponding left and right wing between the wing leading edge and a wing trailing edge and a forward thrust orientation.

15. The aircraft of claim 14, wherein the left and the right ducted fans each comprise a circular duct surrounding a rotor hub from which blades radially extend;
a stator having a stator leading edge and a stator trailing edge; and
a stator chord line extending from the stator leading edge to the stator trailing edge, the stator chord line substantially equal to a duct radius from the rotor hub to an outer surface of the duct;
wherein the stator is positioned in the opening when the left and the right ducted fans are in the forward thrust orientation.

16. The aircraft of claim 15, wherein the stator leading edge is located inside of the duct and extends along a diameter of the duct;
the trailing edge is located exterior of the duct; and
the trailing edge has a semi-circular shape corresponding to the duct radius.

17. The aircraft of claim 15, wherein the stator leading edge is located inside of the duct;
the trailing edge is located exterior of the duct;
the stator has a width exterior of the duct that is substantially equal to an outside diameter of the duct; and
the trailing edge has a semi-circular shape corresponding to the duct radius.

18. The aircraft of claim 15, wherein the stator has a height that tapers down from the stator leading edge toward the stator trailing edge.

19. The aircraft of claim 15, wherein the stator leading edge is located inside of the duct and extends along a diameter of the duct;
the trailing edge is located exterior of the duct;
the trailing edge has a semi-circular shape corresponding to the duct radius; and
the stator has a height that tapers down from the stator leading edge toward the stator trailing edge.

20. The aircraft of claim 15, wherein the wing trailing edge has parabolic cutouts positioned behind the left and the right ducted fan.
